(19) United States
(12) Patent Application Publication
(10) Pub. No.: US 2003/0106583 A1
(43) Pub. Date: Jun. 12, 2003

(54) General-purpose thermally-sensitive safety apparatus

(76) Inventor: Hsi-Kuang Weng, Changhua (TW)

Correspondence Address: BACON & THOMAS, PLLC, 625 SLATERS LANE, FOURTH FLOOR, ALEXANDRIA, VA, 22314

(21) Appl. No.: 10/315,093

(22) Filed: Dec. 10, 2002

(30) Foreign Application Priority Data
Dec. 12, 2001 (TW) 90221713

(51) Int. Cl. F16K 17/38

(52) U.S. Cl. 137/72

(57) ABSTRACT

A safety apparatus is disclosed to include a main body having a chamber, a pin installed in the chamber, and a thermally-sensitive fragile member. The chamber has a top opening, a bottom opening and through holes communicating with outside. A supporting piece is mounted inside the chamber adjacent to the bottom opening. The pin has a base portion and a body portion which is fit with a spring and runs through the top opening of the main body. The thermally-sensitive fragile member has an end positioned on the supporting piece and the other end holding against the pin. When the thermally-sensitive fragile member is shattered at a predetermined temperature, the pin will be driven by a rebounding resilience of the spring to move inwardly into the chamber. The safety apparatus is completely properly for use in a gas switch and a fire alarm device.

### FIELD OF THE INVENTION

The present invention relates generally to thermally-sensitive apparatuses, and more particularly to a general-purpose thermally-sensitive safety apparatus which is properly used in a gas safety device or a fire alarm device.

### BACKGROUND OF THE INVENTION

Generally speaking, there are many kinds of gas cut-out devices for sale, which are mostly controlled by overflow valves such that they are ineffective in avoiding explosions. Afterwards, another gas cut-out device controlled by a microcomputer was made. Although the microcomputer can precisely control the gas cut-out device, the microcomputer is vulnerable to humidity easily resulting in breakdown or malfunction. Accordingly, the conventional mechanical cut-out devices are more safe and dependable than the microcomputer-controlled cut-out devices.

Additionally, there are many fire alarm devices for sale, most of which are provided with microcomputers capable of being thermally sensitive and/or photosensitive for receiving signals. When a default degree of temperature or brightness is reached, the microcomputers will trigger an alarm mechanism, such as speaker or warning lamp or others, to alert people nearby. However, as we all know, the products with microcomputers are though practical, but they are vulnerable to humidity easily resulting in breakdown or malfunction such that they are not 100% safe.

### SUMMARY OF THE INVENTION

The primary objective of the present invention is to provide a general-purpose thermally-sensitive safety apparatus, which is properly for use in a gas safety device or a fire alarm device and is structurally simple and precisely functions.

The foregoing objective of the present invention is attained by the general-purpose thermally-sensitive safety apparatus, which is composed of a main body, a pin, and a thermally-sensitive fragile member. The main body is formed of a chamber inside, which is provided with a top and bottom openings, and a plurality of through holes communicating with the chamber and outside. A supporting piece is installed inside the chamber of the main body adjacent to the bottom opening. The pin, which has a body portion and a base portion, is installed in the chamber of the main body at an end thereof The body portion of the pin is fit with a spring and runs through the top opening. The thermally-sensitive fragile member has an end positioned on the supporting piece and the other end holding against the pin.

### BRIEF DESCRIPTION OF THE DRAWINGS

FIG. 1 is an exploded view of a thermally-sensitive safety apparatus of the present invention;

FIG. 2 is a sectional view of the thermally-sensitive safety apparatus of present invention;

FIG. 3 is a sectional view showing that the safety apparatus of the present invention is used in a gas switch;

FIG. 4 is a sectional view showing that the safety apparatus of the present invention is used in the gas switch and a gas passage of the gas switch is shut off by the safety apparatus;

FIG. 5 is a sectional view showing that the safety apparatus of the present invention is used in another gas switch;

FIG. 6 is a sectional view showing that the safety apparatus of the present invention is used in the gas switch of FIG. 5 and a gas passage of the gas switch is shut off by the safety apparatus;

FIG. 7 is a sectional view showing that the safety apparatus of the present invention is used in an alarm device;

FIG. 8 is a sectional view showing that the safety apparatus of the present invention is used in the alarm device and is in operation;

FIG. 9 is a sectional view showing that the safety apparatus of the present invention is used in another alarm device;

FIG. 10 is a sectional view showing that the safety apparatus of the present invention is used in the alarm device of FIG. 9 and is in operation;

FIG. 11 is a partial sectional view showing that the safety apparatus of the present invention is used in an emergency exit;

FIG. 12 is a partial sectional view showing that the safety apparatus of the present invention is used in the emergency exit and is in operation;

FIG. 13 a sectional view showing that the safety apparatus of the present invention is for use in a domed fire alarm is not in operation;

FIG. 14 is a bottom view of FIG. 13 but a casement of the domed fire alarm is removed; and

FIG. 15 is similar to FIG. 14 but showing that the safety apparatus is in operation while a fire breaks out.

### DETAILED DESCRIPTION OF THE INVENTION

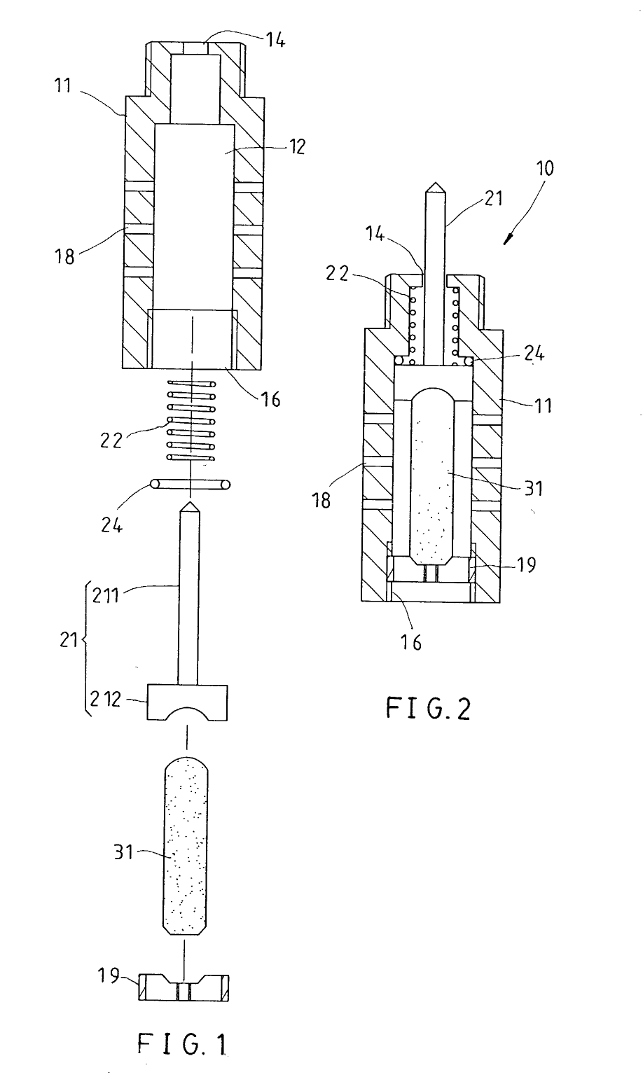

Referring to FIG. 1, a general-purpose thermally-sensitive safety apparatus of the present invention is composed of a main body 11, a pin 21, and a thermally-sensitive fragile member 31.

The main body 11 is provided with a chamber 12 inside, a top opening 14, a bottom opening 16, and a plurality of through holes 18. The top opening 14, the bottom opening 16, and the through holes 18 communicate with the chamber 12 and outside. A supporting piece 19 having a hollow core and a recessed surface is installed in the chamber 12 of the main body 11 adjacent to the bottom opening 16. The pin 21, which is substantially T-shaped, is installed in the chamber 12 of the main body 11 and is made of an insulated material. The pin 21 can be alternatively made of a metal material according to a device in which the present invention is for use. The pin 21 includes a body portion 211 and a base portion 212. The body portion 211 is smaller in outer diameter than the top opening 14 of the main body 11 so as to run through the top opening 14. The body portion 211 is fit with a spring 22, which is greater in outer diameter than the top opening 14 of the main body 11 so as not to run through the top opening 14. In addition, the spring 22 and an inner periphery of the chamber 12 of the main body 11 are installed with a leakproof piece 24 therebetween at a predetermined position. The thermally-sensitive fragile member 31, which is disposed over the supporting piece 19, is positioned on the supporting piece 19 at an end thereof and holds against the base portion 212 of the pin 21 at the other end thereof. When the pin 21 is held against by the thermally-sensitive fragile member 31, the spring 22 is pressured to deform so as to be provided with a rebounding resilience. Accordingly, when the thermally-sensitive fragile member 31 is shattered at a predetermined temperature, the spring 22 will drive the pin 21 to move downward and a presupposed action will be thereby done. Chippings, which are produced while the thermally-sensitive fragile member 31 is shattered, will drain out of the chamber 12 of the main body 11 through the through holes 18.

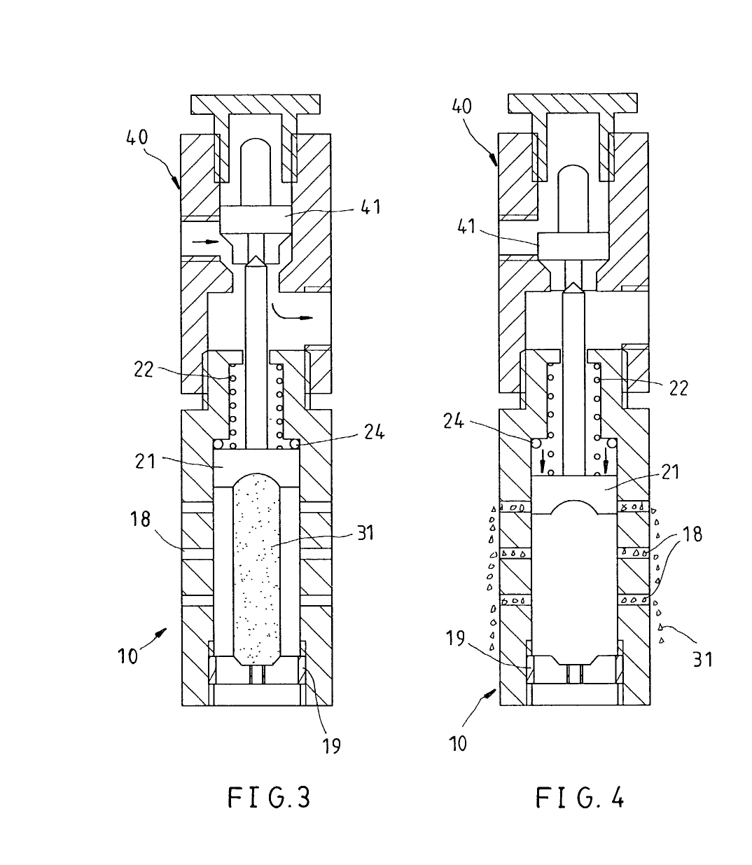

As shown in FIG. 3, the present invention is used in a gas switch 40, inside which a cut-out member 41 is installed and a gas passage is provided. The pin 21 is held against at a fixed position by the thermally-sensitive fragile member 31 such that the cut-out member 41 of the gas switch 40 is held against a front end of the pin 21 and the gas passage of the gas switch 40 is thereby clear for flowing without obstruction. When the ambient temperature around the gas switch 40 reaches a predetermined degree and the thermally-sensitive fragile member 31 is gradually shattered, as shown in FIG. 4, a resistance provided by the thermally-sensitive fragile member 31 to hold against the pin 21 is vanished and the pin 21 is driven to move downward by the rebounding resilience of the spring 22. In the meantime, the cut-out member 41 moves downward to shut off the passage of the gas switch 40. Accordingly, the gas switch 40 is prevented from explosions due to the ambient temperature being too high so as to be blastproof-effective.

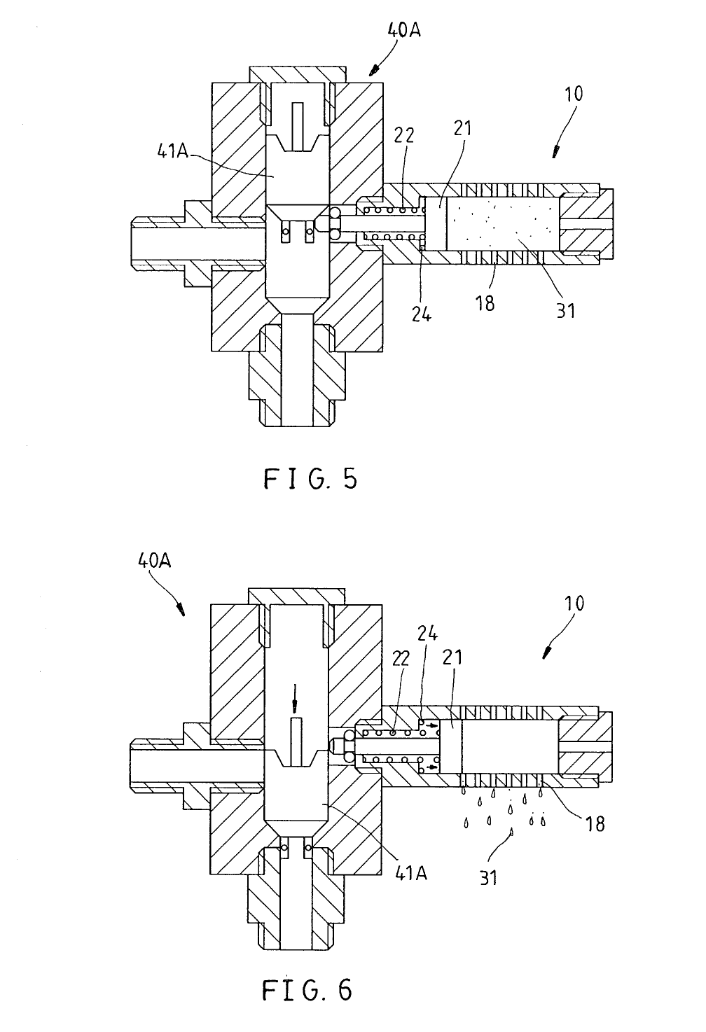

Referring to FIGS. 5 and 6, the general-purpose thermally-sensitive safety apparatus 10 is laterally mounted to another gas switch 40A. The pin 21 holds against the cut-out member 41A such that the passage of the gas switch 40A keeps clear without obstruction. When the thermally-sensitive fragile member 31 is shattered at the predetermined temperature, the pin 21 disengages the resistance against the cut-out member 41A by the rebounding resilience of the spring 22 such that the cut-out member 41A moves downward and shuts off the passage of the gas switch 40A. Accordingly, the gas switch 40A is likewise blastproof-effective.

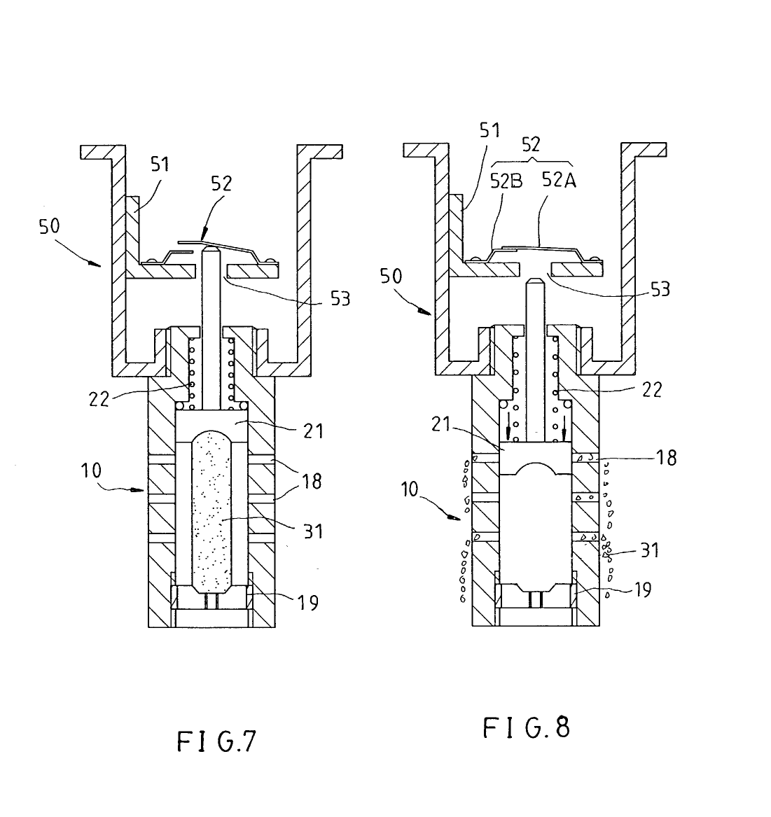

Referring to FIG. 7, the thermally-sensitive safety apparatus 10 is mounted on an alarm device 50. The alarm device 50 includes an insulator 51 and two electrically-conductive elastic sheets 52. The insulator 51 is substantially L-shaped and is provided with an orifice 53 running therethrough for the body portion 211 of the pin 21 running through. The two electrically-conductive elastic sheets 52 are respectively disposed at two sides of the orifice 53. The body portion 211 of the pin 21 holds against one of the electrically-conductive elastic sheets 52 to prevent the two electrically-conductive elastic sheets 52 from contacting with each other, and thereby the two electrically-conductive elastic sheets 52 are kept electrically disconnected with each other. When the thermally-sensitive fragile member 31 is shattered at the predetermined temperature, as shown in FIG. 8, the pin 21 is driven to move downward by the spring 22 and then one of electrically-conductive elastic sheet 52A rebounds to be electrically connected with the other electrically-conductive elastic sheets 52B. Accordingly, an alarm mechanism (not shown) of the alarm device 50, such as siren or warning lamp, will be triggered such that the alarm device 50 is warning-effective.

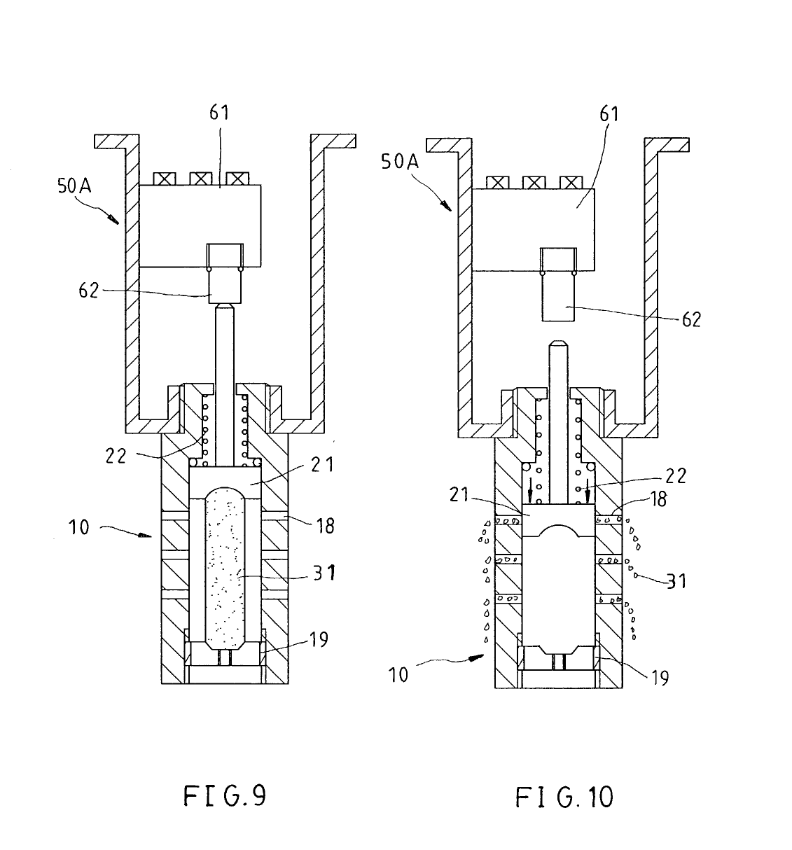

Referring to FIG. 9, the safety apparatus is used in another alarm device 50A having a limit switch 61, which has a contact button 62, instead of the insulator 51 and the two electrically-conductive elastic sheets 52 in the foregoing embodiment. In the meantime, the pin 21 holds against the button 62 of the limit switch 61. When the thermally-sensitive fragile member 31 is shattered at the predetermined temperature, as shown in FIG. 10, the pin 21 is driven to move downward by the spring 22 such that a resistance provided by the pin 21 against the button 62 of the contact-sensitive switch 61 is vanished. Meanwhile, a signal will be internally transmitted to trigger an alarm mechanism of the alarm device 50A. It is to be noted that the way of transmitting the signal of the alarm device 50 can be either electrical wires or radios to make the alarm mechanism work.

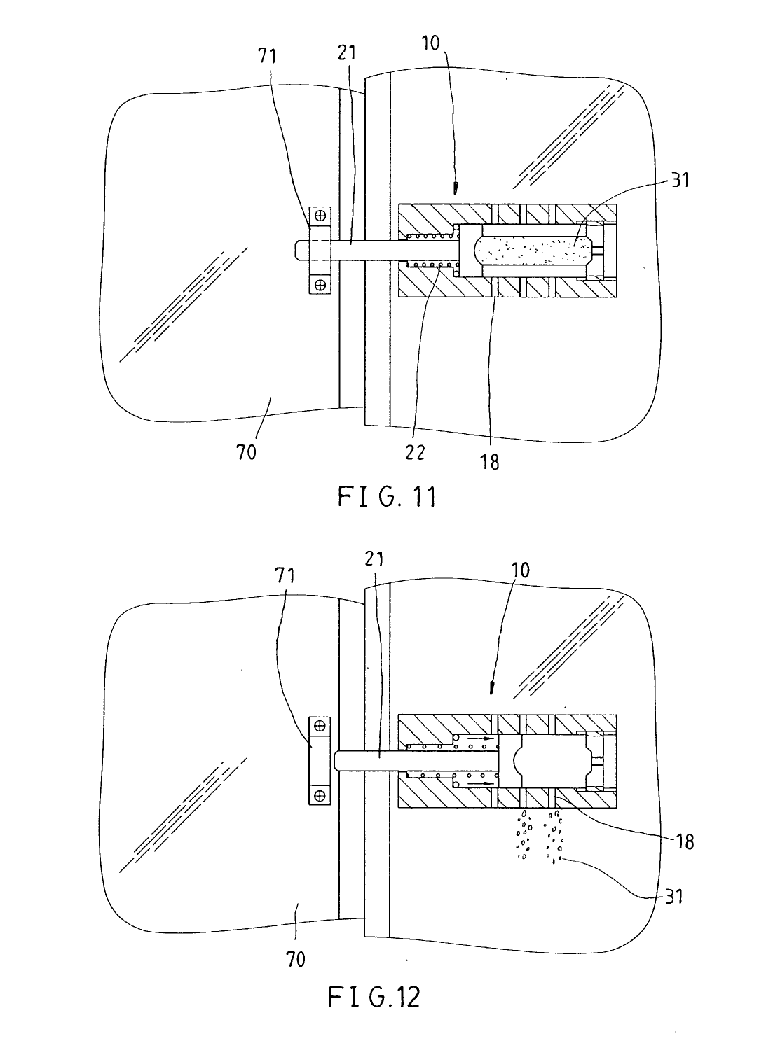

Referring to FIG. 11, the thermally-sensitive safety apparatus 10 is mounted on an emergency exit 70 and works as a lock. While in regular temperature around the emergency exit 70, the body portion 211 of the pin 21 runs through a lock hole 71 of the emergency exit 70 to lock the emergency exit 70. When the ambient temperature is abnormally high, like a fire breaking out nearby, and the thermally-sensitive fragile member 31 is shattered at the predetermined temperature, which is no greater than the ambient temperature, as shown in FIG. 12, the pin 21 is driven to automatically unlock the emergency exit 70 by the spring 22. Accordingly, while a building is on fire, people living in the building can immediately escape out of the building through the emergency exit 70. However, the conventional emergency exit 70 is usually locked by a mechanical lock and a key to unlock the mechanical lock can be frequently unavailable because of a panic. Besides, unlocking the emergency exit 70 with the key will waste the valuable time of escape. Therefore, installing the present invention on the emergency exit 70 will increase the time to escape and the chance to survive while a fire breaks out.

Additionally, when the people are aware of the fire early and the ambient temperature is not high enough for the thermally-sensitive fragile member 31 to be shattered, insert a tool having a long body portion, such as screwdriver, into the through holes 18 of the thermally-sensitive safety apparatus 10 and shatter the thermally-sensitive fragile member 31, and thereby the emergency exit 70 can be unlocked.

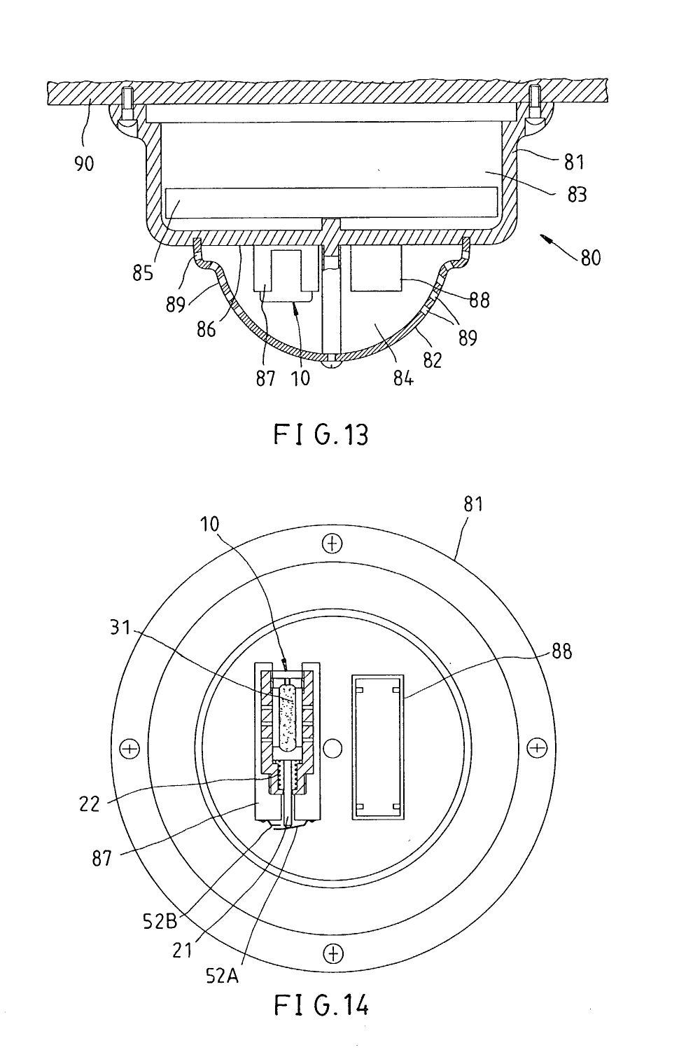

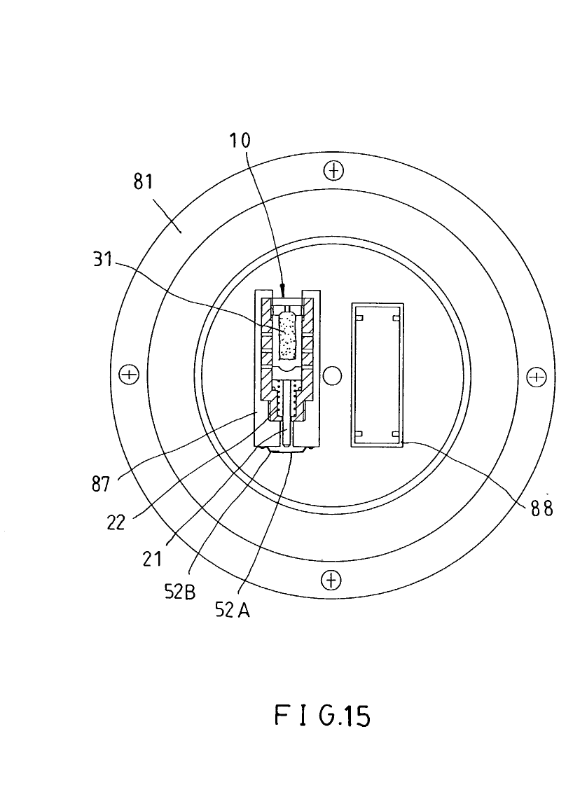

Referring to FIGS. 13 and 14, the thermally-sensitive safety apparatus 10 is transversally mounted in a domed fire alarm device 80, which is screwed onto and hung under a ceiling 90. The domed fire alarm device 80 includes a main frame 81 and a casement 82, which are corresponsively combined with each other. The main frame 81 and the casement 82 are respectively provided with a first receiving room 83 and a second receiving room 84. The main frame 81 is made of a heatproof material and is in shape of a hollow cylinder. An integrated circuit (IC) board 85 is installed in the first receiving room 83 of the main frame 81. A slotted mount 87 and a battery carrier 88 are mounted on a top surface 86 of the main frame 81. The slotted mount 87, which is provided for fastening the thermally-sensitive safety apparatus 10, has two electrically-conductive elastic sheets 52A and 52B at an end. The battery carrier 88 is provided for receiving at least one battery (not shown) and for supplying a power source to keep the IC board 85 work. The casement 82, which is made of an excellently thermally-conductive material and is substantially bowl-shaped, is corresponsively mounted on the top surface 86 of the main frame 81 so as to cover the thermally-sensitive safety apparatus 10 and the battery carrier 88. The casement 82 is provided with a plurality of air holes 89 for enhancing thermal sensitivity of the thermally-sensitive safety apparatus 10 such that the present invention can be warning-effective much sooner while a fire breaks out.

While in normal situation (not on fire), as shown in FIG. 14, the pin 21 of the thermally-sensitive safety apparatus 10 holds against and over the electrically-conductive elastic sheet 52A such that the IC board 85 is not electrically charged and will not work. As shown in FIG. 15, while a fire accident occurs to result in that the thermally-sensitive fragile member 31 is shattered at the predetermined temperature, the pin 21 moves inward by the spring 22 such that the two electrically-conductive elastic sheet 52A and 52B are electrically connected with each other. Accordingly, the IC board 85 is electrically charged to work and triggers a siren or a warning lamp to be warning-effective.

It is to be noted that the thermally-sensitive fragile member 31 of the present invention can be interchanged by a thermally-sensitive fusible member, which will melt at a predetermined temperature and thereby the thermally-sensitive safety apparatus 10 will achieve the aforementioned predetermined effect.

In conclusion, the present invention provides a general-purpose thermally-sensitive safety apparatus, which is completely properly for use in the gas switch and the fire alarm device and precisely works without errors and is structurally simple to be cost-effective.

What is claimed is:

1. A general-purpose thermally-sensitive safety apparatus, comprising:
a main body having a chamber, a top opening, a bottom opening, and a plurality of through holes, wherein said top and bottom openings and the through holes communicate with said chamber and outside;
a supporting piece mounted in said chamber adjacent to said bottom opening;
a pin installed in said chamber of said main body and having a body portion and a base portion, said body portion being fit with a spring and running through said top opening; and
a thermally-sensitive fragile member having an end positioned on said supporting piece inside said chamber of said main body and the other end holding against said base portion of said pin.

2. The safety apparatus as defined in claim 1, wherein said pin is T-shaped and is made of an insulated material.

3. The safety apparatus as defined in claim 1, wherein said pin is made of a metal material.

4. The safety apparatus as defined in claim 1, wherein said body portion of said pin is smaller in outer diameter than said top opening of said main body, and said spring is greater in outer diameter than said top opening of said main body.

5. The safety apparatus as defined in claim 1, wherein said thermally-sensitive fragile member will drain out of said main body through said through holes while said thermally-sensitive fragile member is shattered at a predetermined temperature.

6. The safety apparatus as defined in claim 1, wherein said spring and the inner periphery of said chamber of said main body are installed with a leakproof piece therebetween.

7. The safety apparatus as defined in claim 1 being used in a flow cut-out device of a gas switch.

8. The safety apparatus as defined in claim 1 being used in a fire alarm device.

9. The safety apparatus as defined in claim 1, wherein said thermally-sensitive fragile member is a thermally-sensitive fusible member.

10. The safety apparatus as defined in claim 1 being used in an emergency exit.

11. The safety apparatus as defined in claim 1 being transversally mounted in a domed fire alarm.

12. The safety apparatus as defined in claim 11, wherein said domed fire alarm comprises a casement having a plurality of air holes thereon.
